(19) United States
(12) Patent Application Publication
(10) Pub. No.: US 2015/0369587 A1
(43) Pub. Date: Dec. 24, 2015

(54) SD-OCT Flatten Coherence Length by Controlling Spatial Dispersion

(71) Applicant: CANON KABUSHIKI KAISHA, Tokyo (JP)

(72) Inventor: Takefumi OTA, Nagareyama-shi (JP)

(21) Appl. No.: 14/741,239

(22) Filed: Jun. 16, 2015

Related U.S. Application Data
(60) Provisional application No. 62/013,962, filed on Jun. 18, 2014.

(51) Int. Cl. G01B 9/02

(52) U.S. Cl. CPC G01B 9/02043; G01B 9/02091

(57) ABSTRACT

A spectral domain optical coherence tomograph comprising: a light source, a beamsplitter, a reference arm, a dispersive device, and a sensor array. Wherein the dispersive device is a spatial chromatic dispersive device that spreads an interference light signal produced by the beamsplitter. Wherein each pixel in the sensor array is identified by an index i. Wherein the sensor array may be positioned relative to the dispersive device such that each pixel i detects wavelengths of the interference light having: a spectral width Δλᵢ; a central wavelength λ_{ci}; having a coherence length defined as

$$Δ {l}_{i} ∝ \frac{{λ}_{ci}^{2}}{Δ {λ}_{i}} .$$

Wherein a reflective or refractive optical element is placed between the dispersive device and the sensor array to transform the spatial chromatic dispersion such that Δli=Δli+j is obtained for each pixel in the sensor array.

### CROSS REFERENCE

This application claims the benefit of the U.S. provisional application No. 62/013,962 filed on Jun. 18, 2014. U.S. provisional application No. 62/013,962 is incorporated by reference herein in its entirety.

### BACKGROUND

1. Field of Art

The present disclosure relates to a spectrum domain optical coherence tomography apparatus.

2. Description of Related Art

In spectrum domain optical coherence tomography (SD-OCT) with a line-sensor as detector for detecting spectrum interference signal, each coherence length at each pixel of the line-sensor is determined by a center wavelength and spectrum width detected at the each pixel. So far, since the detected spectrum width has not been considered, the coherence length at each pixel is changed according to the each pixel. Therefore, there have been problems as follows in SD-OCT.

Depth resolution, which is determined by total spectrum width of spectrum interference signal, is changed according to the depth.

In spectroscopic SD-OCT, the spectrum information is changed by the depth.

Effect of scattering or absorption of target sample cannot be canceled, and thus the depth resolution is deteriorated by characteristics of the target sample.

Sharpness of OCT images is changed depending on the depth as the depth resolution depends on the depth. As the sharpness of the images is optimized at near range, it is difficult to obtain the OCT image deep within the tissue because of the attenuation of the OCT signal and the deterioration of the depth resolution. For full eye imaging, since the length to the edge of the eye is longer than the length to the center of the eye, the resolution at the edge of the eye deteriorates. Thus it is difficult to obtain uniform OCT images.

Meanwhile, several functional OCT technologies that can obtain not only tissue but also structures, flow and components by use of polarization, Doppler frequency or spectrum information have been developed. In the spectroscopic OCT, the spectrum at a depth is obtained by calculating a Fourier transform of a signal which is generated by multiplying a window to the A-scanned signal at around the depth. Here, if the coherence length at each pixel depends on the wavelength at each pixel, spectroscopic spectrum is changed depending on the depth. Thus the obtained spectroscopic spectrum is not accurate. The spectroscopic OCT is described in “Spectroscopic optical coherence tomography”, U. Morgner, W. Drexler, F. X. Kärtner, X. D. Li, C. Pitris, E. P. Ippen, and J. G. Fujimoto, Optics Letters, Vol. 25, Issue 2, pp. 111-113 (2000).

### SUMMARY

In one embodiment, a spectral domain optical coherence tomograph may comprise: a light source, a beamsplitter, a reference arm, a dispersive device, and a sensor array. Wherein the dispersive device may be a spatial chromatic dispersive device that spreads an interference light signal produced by the beamsplitter such that different wavelengths of the interference light signal are directed at different areas of space. Wherein the sensor array may comprise a plurality of N pixels. Wherein each pixel in the sensor array is identified by an index i. Wherein the sensor array may be positioned relative to the dispersive device such that each pixel i detects wavelengths of the interference light having: a spectral width Δλᵢ; a central wavelength λ_{ci}; having a coherence length defined

$$Δ {l}_{i} ∝ \frac{{λ}_{ci}^{2}}{Δ {λ}_{i}} .$$

Wherein a reflective or refractive optical element may be placed between the dispersive device and the sensor array to transform the spatial chromatic dispersion such that Δli=Δli+j is obtained for each pixel in the sensor array.

In another embodiment, a spectral domain optical coherence tomograph may comprise: a light source, a device for splitting light, a reference arm, a dispersive device, and a sensor array. Wherein the dispersive device may be a spatial chromatic dispersive device that spreads an interference light signal produced by the device for splitting light such that different wavelengths of the interference light signal are directed at different areas of space. Wherein the spectral domain optical coherence tomography may be configured so that a ratio between the maximum and minimum of the interfered spectral signal intensity may be equal to or more than a predetermined value when the average of spectral intensity is ½.

In an alternative embodiment, a spectral domain optical coherence tomograph may further comprise a reflective optical element placed between the dispersive device and the sensor array so that the ratio between the maximum and minimum of the interfered spectral signal intensity may be equal to or more than the predetermined value when the average of spectral intensity is ½.

In an alternative embodiment, a spectral domain optical coherence tomograph may further comprise a refractive optical element placed between the dispersive device and the sensor array so that the ratio between the maximum and minimum of the interfered spectral signal intensity may be equal to or more than the predetermined value when the average of spectral intensity is ½.

In an alternative embodiment, a spectral domain optical coherence tomograph may further comprise a reflective optical element placed between the dispersive device and the sensor array so that spectral loss by sample is compensated.

In an alternative embodiment, a spectral domain optical coherence tomograph may further comprise a refractive optical element placed between the dispersive device and the sensor array so that spectral loss by sample is compensated.

In an alternative embodiment of a spectral domain optical coherence tomograph a reflective optical element may be placed between the dispersive device and the sensor array to transform the spatial chromatic dispersion so that spectral loss by sample is compensated.

In an alternative embodiment of a spectral domain optical coherence tomograph a refractive optical element may be placed between the dispersive device and the sensor array to transform the spatial chromatic dispersion so that spectral loss by sample is compensated.

In an alternative embodiment of a spectral domain optical coherence tomograph the line-sensor has a designed pitch such that spectral loss by sample may be compensated.

In an alternative embodiment of a spectral domain optical coherence tomograph the line-sensor has a designed pitch so that the ratio between the maximum and minimum of the interfered spectral signal intensity may be equal to or more than the predetermined value when the average of spectral intensity is ½.

In an alternative embodiment of a spectral domain optical coherence tomograph the sensor array may be arranged so that the ratio between the maximum and minimum of the interfered spectral signal intensity may be equal to or more than the predetermined value when the average of spectral intensity is ½.

In an alternative embodiment of a spectral domain optical coherence tomograph the predetermined value may be ½.

In another embodiment of a spectral domain optical coherence tomograph may comprise: a light source; a device for splitting light; a reference arm; a dispersive device; and a sensor array. Wherein the dispersive device may be a spatial chromatic dispersive device that spreads an interference light signal produced by the device for splitting light such that different wavelengths of the interference light signal are directed at different areas of space. Wherein the sensor array comprises a plurality of pixels. Wherein each pixel in the sensor array is identified by an index i. Wherein the sensor array may be positioned relative to the dispersive device such that each pixel i detects wavelengths of the interference light having: a spectral width Δλᵢ; a central wavelength λ_{ci}; having a coherence length defined as

$$Δ {l}_{i} ∝ \frac{{λ}_{ci}^{2}}{Δ {λ}_{i}} .$$

Wherein the spectral domain optical coherence tomograph may be configured so that Δli is substantially identical to Δli+j.

In an alternative embodiment of a spectral domain optical coherence tomograph may further comprise a reflective optical element placed between the dispersive device and the sensor array so that Δli is substantially identical to Δli+j.

In an alternative embodiment of a spectral domain optical coherence tomograph may further comprise a refractive optical element placed between the dispersive device and the sensor array so that Δli is substantially identical to Δli+j.

In an alternative embodiment of a spectral domain optical coherence tomograph the line-sensor may have a designed pitch so that Δli is substantially identical to Δli+j.

In an alternative embodiment of a spectral domain optical coherence tomograph wherein the sensor array may be arranged so that Δli is substantially identical to Δli+j.

### BRIEF DESCRIPTION OF THE SEVERAL VIEWS OF THE DRAWINGS

The accompanying drawings, which are incorporated in and constitute a part of the specification, illustrate exemplary embodiments.

FIG. 1 is an illustration of an SD-OCT.

FIG. 2 is an illustration of a relative position of a line sensor to a dispersive device as used in an embodiment.

FIGS. 3A-B are illustrations of the performance of embodiments.

FIGS. 4A-E are illustrations of the performance of embodiments.

FIG. 5 is an illustration of an embodiment.

FIGS. 6A-B are illustrations of the performance of embodiments.

FIGS. 7A-B are illustrations of embodiments.

FIGS. 8A-B are illustrations of embodiments.

FIGS. 9A-B are illustrations of embodiments.

FIG. 10 is an illustration of an embodiment.

FIGS. 11A-B are illustrations of the performance of embodiments.

FIG. 12 is an illustration of the loss by scattering and absorption of water and blood.

### DETAILED DESCRIPTION

In this disclosure, a pattern of spectrum dispersion on a line-sensor is controlled so as to address the issues listed above. In addition, the obtained spectrum interference signal is reshaped by calculation based on the coherence length information depending on the pixels.

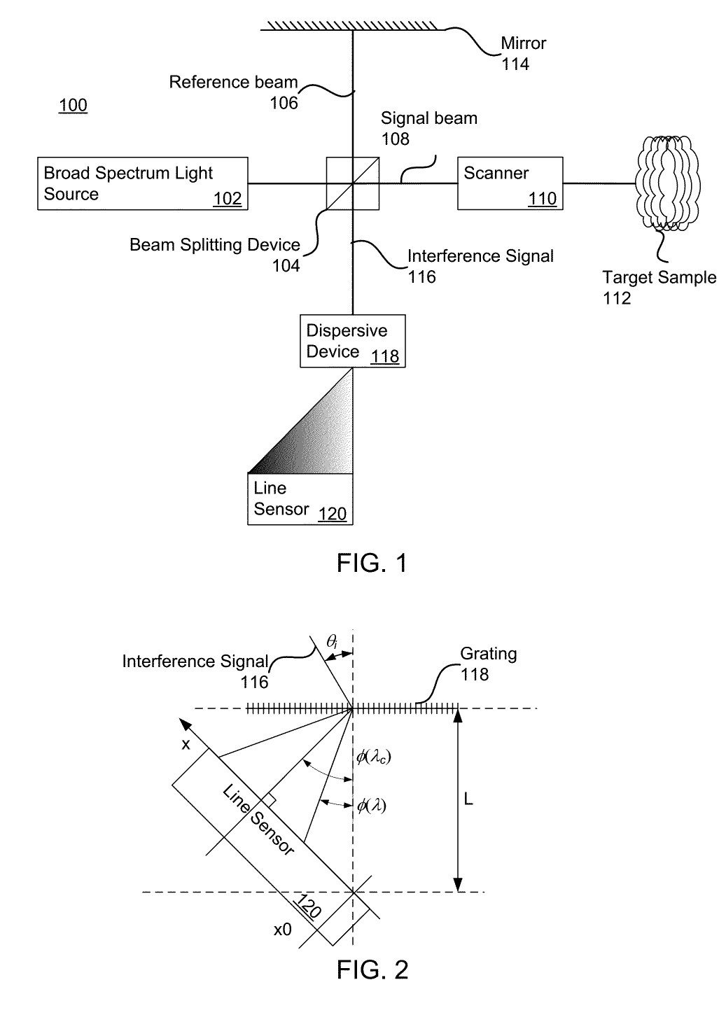

FIG. 1 shows the schematics of the SD-OCT 100. Output from a light source 102 has a broad spectrum width and is coupled into beam splitting device 104 such as beam splitter or a fused fiber coupler. At the beam splitting device 104, the light is separated into a signal beam 108 and a reference beam 106. The signal beam 108 goes to a scanning device 110 such as a scanner for scanning the target sample 112 by changing the optical path, and irradiating the target sample 112. At the target sample, the irradiated signal beam 108 is reflected or backscattered and coupled to the beam splitting device 104. On the other hand, the reference beam 106 is propagated along a reference arm, reflected at the end of the reference arm by a mirror 114 and goes back to the beam splitting device 104. At the beam splitting device 104, an interference signal 116 is generated by overlapping the lights backscattered/reflected from the target sample 112 and the reference beam 106 that has come back along the reference arm. The interference signal light is dispersed spatially by dispersive device 118 such as a grating, a prism or some other device which spatially disperses light according to its wavelength, and irradiates a line sensor 120.

The line sensor may be set to satisfy that the angle φ(Aλ_{c}) between optical path of center wavelength λ_{c} and the line sensor 120 is vertical as shown in FIG. 2. Tilted angle of the line sensor is described as following equations (1) and (2). The relevant parameters are listed following equations (1) and (2).

θₛₑₙₛₒᵣ=φ(λ_{c}) (1)

φ(λ_{c})=sin⁻¹(mλ_{c}d−sin(θᵢ)) (2)

λ: Wavelength (λₛ<λ<λ₁)
λₗ: Longest wavelength
λₛ: Shortest wavelength
λ_{c}: Center wavelength
L: Distance between gratings
θₛₑₙₛₒᵣ: Line-sensor angle
Sizeₛₑₙₛₒᵣ: Line-sensor size
m: Deflection order
d: Density of grating [lines/mm]
θᵢ: Light incident angle to grating
φ(λ): Deflected angle

As illustrated in FIG. 2, the x axis means the position on the line sensor 120. The wavelength λ at x is described by equation (3).

$$λ ( x ) = ( \frac{x \cdot sin ( {θ}_{sensor} )}{\sqrt{{x}^{2} + {L}^{2} - 2 \cdot x \cdot L \cdot cos ( {θ}_{sensor} )}} + sin ( {θ}_{i} ) ) \times \frac{1}{md} \qquad ( 3 )$$

Here. L may be calculated using equation (4).

$$L = {Size}_{sensor} \times {( \frac{sin ( φ ( {λ}_{l} ) )}{sin ( φ ( {λ}_{l} ) + {θ}_{sensor} )} - \frac{sin ( φ ( {λ}_{s} ) )}{sin ( φ ( {λ}_{s} ) + {θ}_{sensor } )} )}^{- 1} \qquad ( 4 )$$

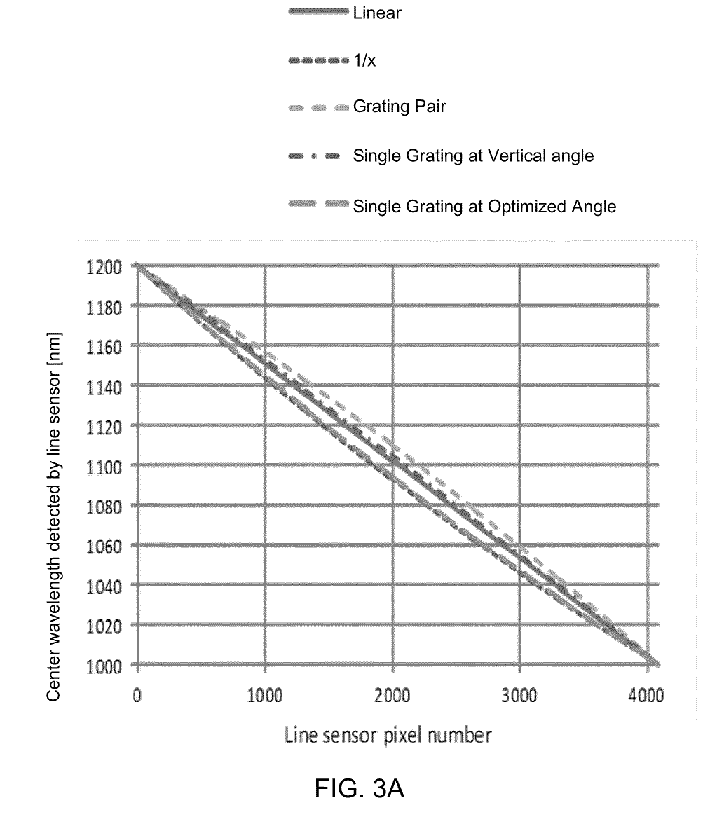

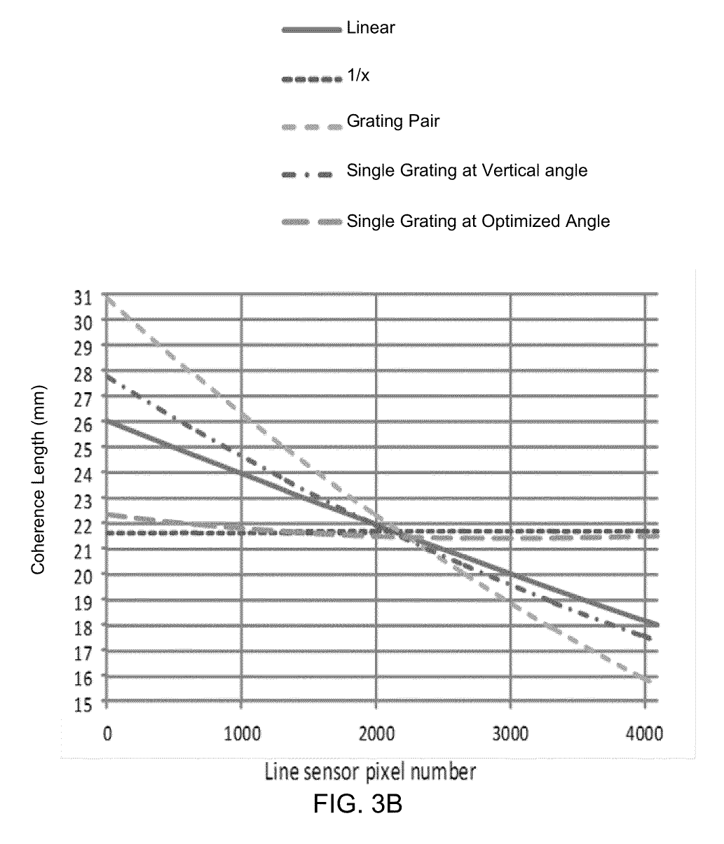

The detected wavelength at each pixel is illustrated by the data line Single grating at vertical angle in FIG. 3A. In which the light source 102 outputs a spectrum with 1000-1200 nm range and the line-sensor 120 has 4096 pixels (n). Groove number d of the grating is 980 [lines/mm], and the incident angle θᵢ is 46.5 degree. The pixel size Δx is 7 μm because of a 28.6 mm sensor size (Sizeₛₑₙₛₒᵣ) and has 4096 pixels (n).

Coherence length Δl can be estimated using center wavelength λ_{c}_{_{—}}ₚᵢₓₑₗ and the spectrum width Δλₚᵢₓₑₗ as described by the following equation (5).

$$Δ l ∝ \frac{{λ}_{c\_pixel}^{2}}{{Δλ}_{pixel}} \qquad ( 5 )$$

The center wavelength λ_{c}_{_{—}}ₚᵢₓₑₗ and spectral width Δλₚᵢₓₑₗ at a pixel can be derived from equation (3). FIG. 3B illustrates the coherence length at each pixel by assigning the values of the center wavelength λ_{c}_{_{—}}ₚᵢₓₑₗ and the spectral width Δλₚᵢₓₑₗ to equation (5).

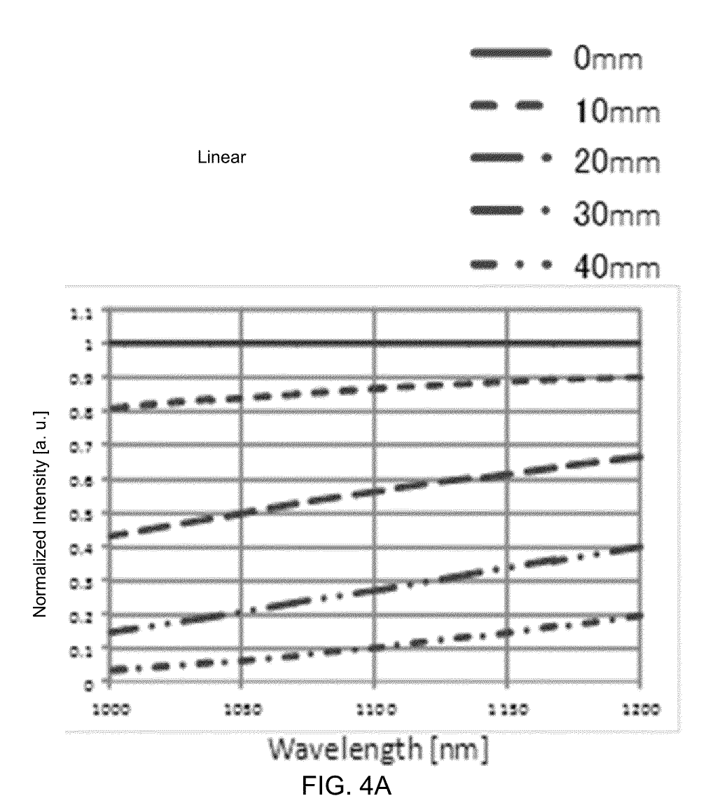

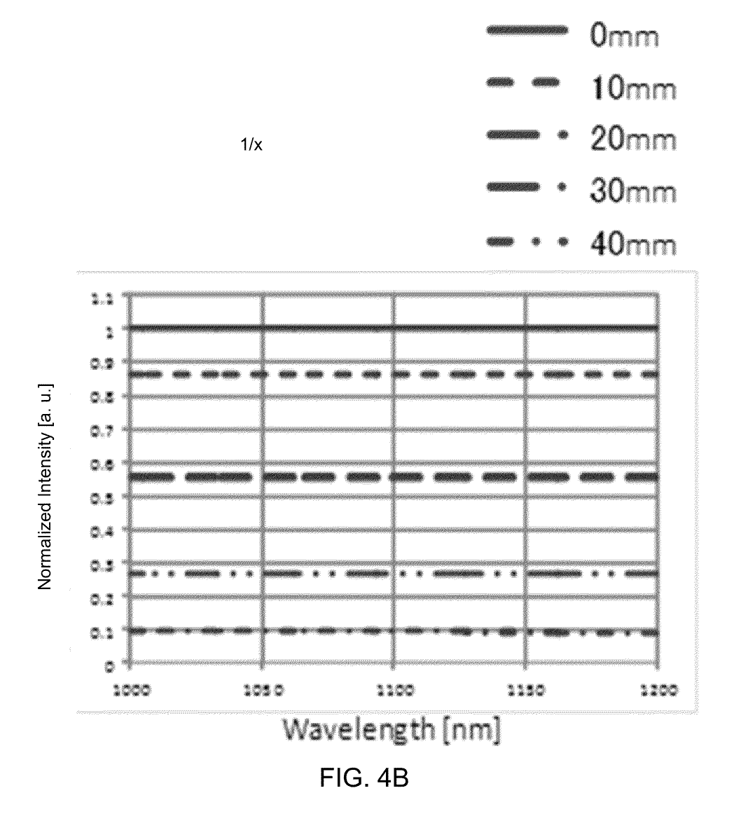

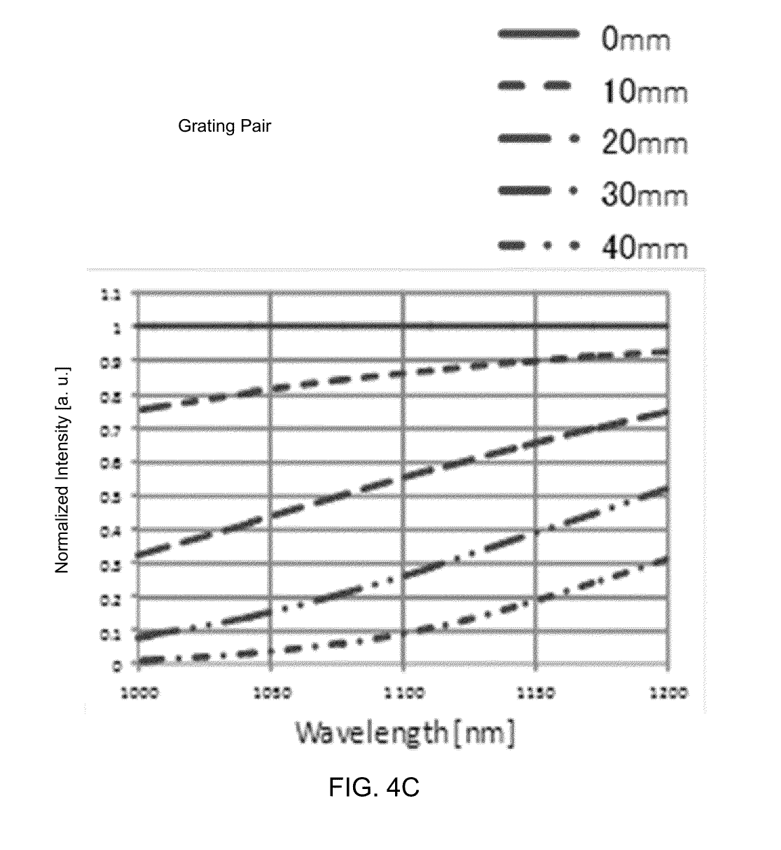

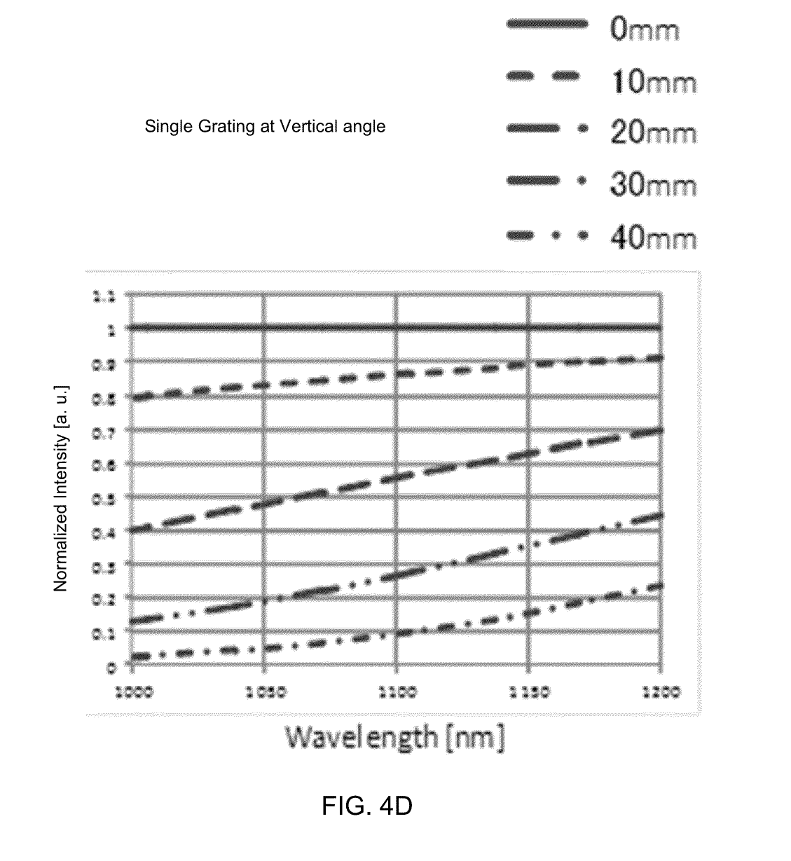

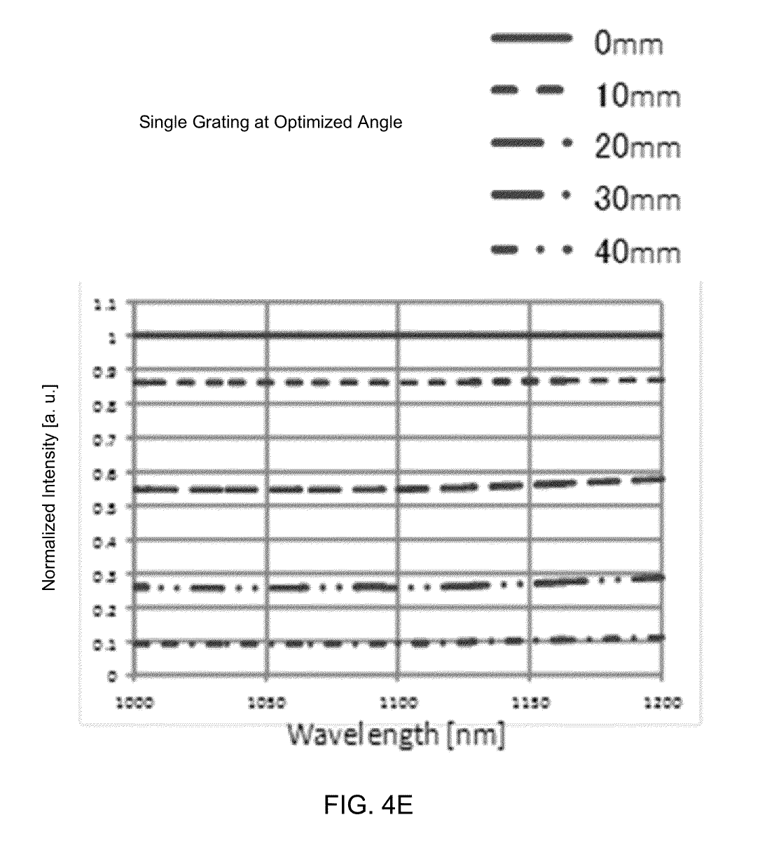

As the Interference signal intensity decays depending on Gaussian function when the difference of the optical lengths between signal and reference path in OCT is varied from 0 to 40 mm, the spectral intensity changes as illustrated in FIGS. 4A-E. FIG. 4D illustrates the situation in which the line sensor 120 is set to satisfy that the angle between optical path of the center wavelength λ_{c} and line sensor 120 is vertical. In this situation, the intensity at shorter wavelength λₛ decays more than the intensity at longer wavelength λₗ. Therefore, the resolution of SD-OCT image is deteriorated as the different optical path length between signal and reference path in OCT is larger. Moreover, as the SD-OCT is expanded to a spectroscopic OCT, the accuracy of the spectroscopic information cannot be obtained.

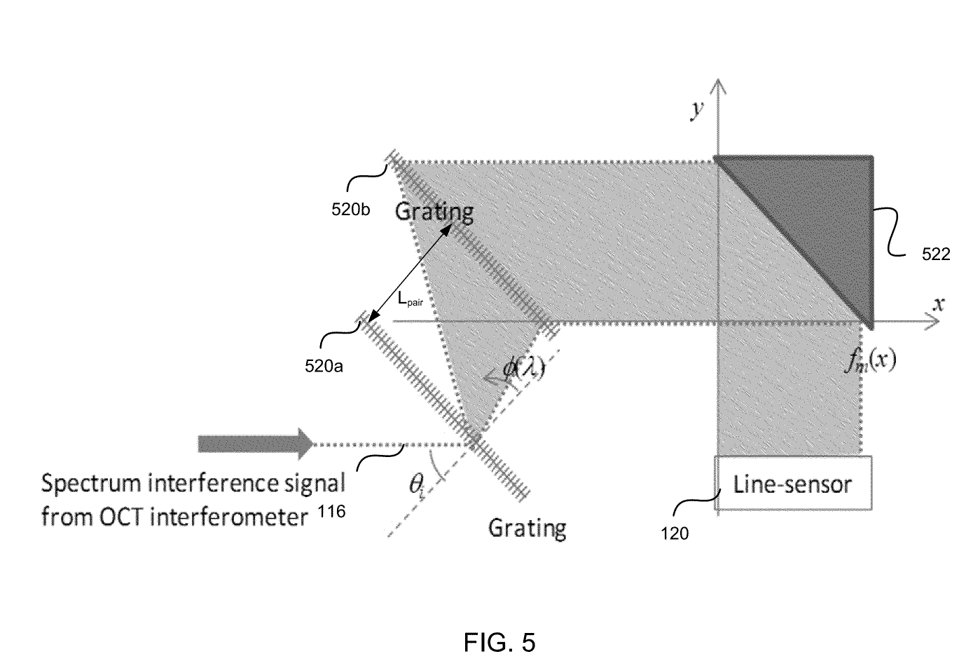

FIG. 5 is an illustration in which a setting of a grating pair 520a-b is used for achieving an apparatus in which the optical axes with different wavelengths are parallel as the light exits the second grating 520b. The X axis is parallel to the line sensor 120 and the y axis is vertical to the x axis. As the interference light 116 from SD-OCT 100 is irradiated onto the first grating 520 in the direction parallel to the x axis, the dispersed light is also parallel to the x axis as shown in FIG. 5. The y value of a wavelength λ is described as follows in equation (6).

y(λ)=L×cos(θᵢ)×(tan(φ(λ))−tan(φ)(λₛ)) (6)

φ(λ)=sin⁻¹(mλd−sin(θᵢ)) (7)

Transforming y value to x value for irradiating the light vertical onto the line sensor 120 by use of a mirror 522, x value is described as in equation (8).

x(λ)=−Lₚₐᵢᵣ×cos(θᵢ)×(tan(φ)(λ))−tan(φ(λₛ)) (8)

In which Lₚₐᵢᵣ is the distance between the first grating 520a and the second grating 520b. The detected wavelength at each pixel is illustrated by the data line grating pair in FIG. 3A. Same as above, the light source 102 outputs a spectrum with 1000-1200 nm range and line-sensor 120 has 4096 pixels (n). Groove number d of the grating is 980 [lines/mm], and the incident angle θᵢ is 46.5 degree. The pixel size Δx is 7 μm because of a 28.6 mm sensor size (Sizeₛₑₙₛₒᵣ) and 4096 pixels (n). The coherence length is illustrated in FIG. 3B by data line “grating pair”.

While the spectral intensity is changed as illustrated in FIG. 4C. The resolution of SD-OCT image deteriorates as the difference in the optical path length between signal and reference path in the OCT 100 increases. Moreover, as the SD-OCT 100 is expanded to a spectroscopic OCT, the accuracy of the spectroscopic Information cannot be obtained.

In order to accomplish the goal of having the coherence lengths being substantially the same or substantially identical at all pixels, the spectrum interference signal should be dispersed in accordance with equation (9). In the context of the present disclosure, substantially the same or substantially identical means that the values are equal to the extent that is possible given the positioning tolerances and optical tolerances of the components of which the system is made out of.

$$λ ( x ) = - a \cdot ( \frac{1}{x + {X}_{1}} + {X}_{2} ) + {λ}_{0} \qquad ( 9 )$$

Here, x is a coordinate on the x axis which is parallel to the axis of propagating light which is dispersed by the grating pair 520a-b, a is coefficient for changing the curve of the dispersed function, λ₀ is center wavelength of light output from light source, X₁ and X₂ are coefficients described in equations (10) and (11) as follows.

$$\begin{matrix}{X}_{1} = \frac{Δ x \pm \sqrt{( n \cdot ( n - 2 ) + 1 ) \cdot Δ {x}^{2} + \frac{4 a}{Δλ} \cdot ( n - 1 ) \cdot Δ x}}{2} & ( 10 ) \\ {X}_{2} = \frac{1}{2} \cdot ( \frac{1}{( - \frac{n}{2 } ) \cdot Δ x + {X}_{1}} + \frac{1}{( \frac{n}{2} - 1 ) \cdot Δ x + {X}_{1}} ) & ( 11 )\end{matrix}$$

Δx is the pixel size, Δλ is spectral width output from light source 102, and n is the number of pixels in the line-sensor 120.

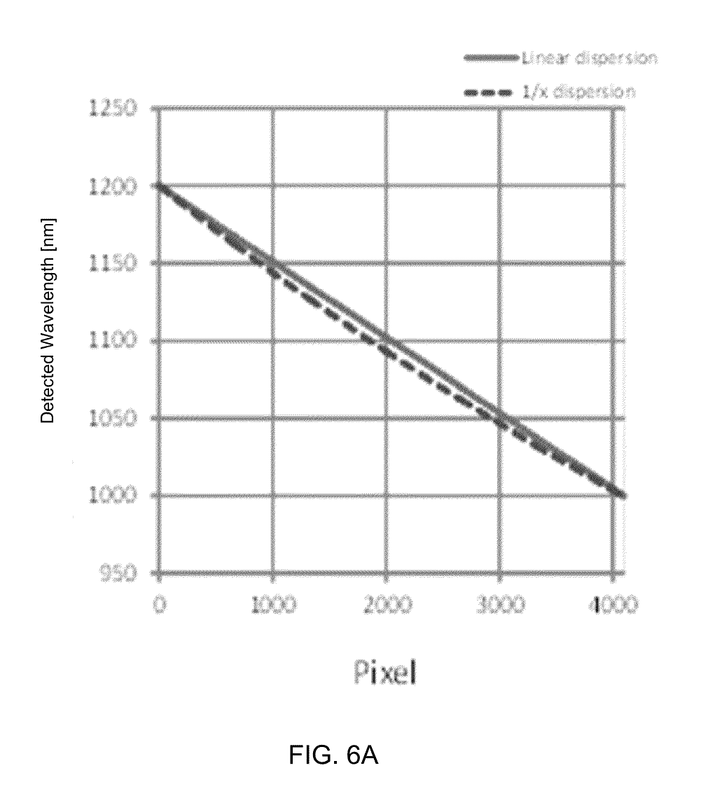

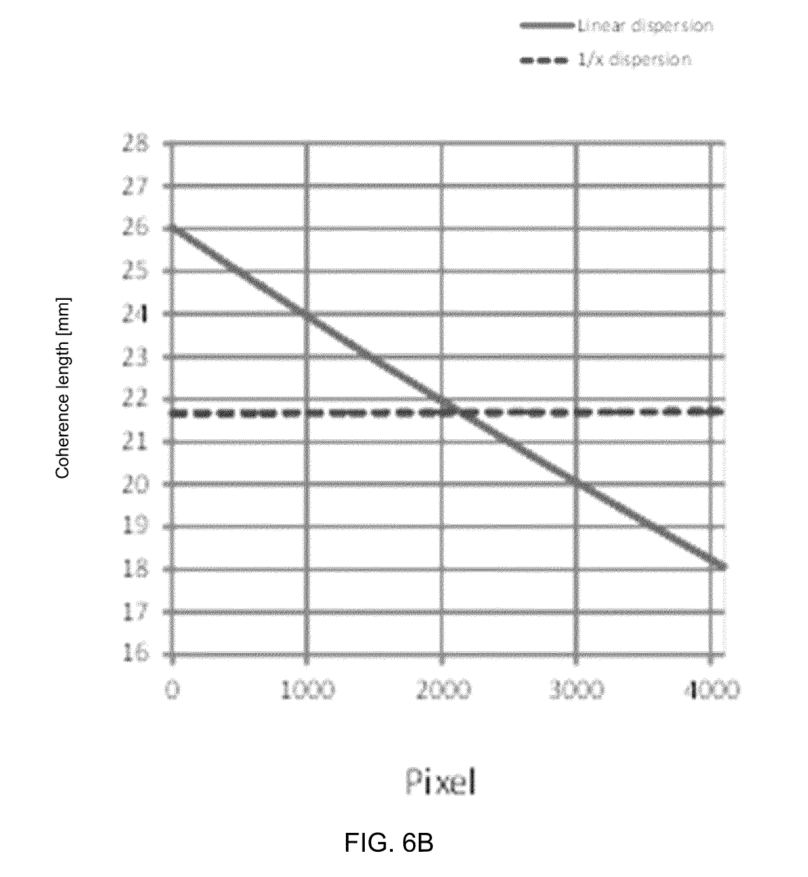

FIGS. 6A-B illustrated the detected wavelength and coherence length at each pixel, respectively. In FIGS. 6A-B, the light source 102 outputs a spectrum with 1000-1200 nm range and line-sensor 120 has 4096 pixels (n). The coefficient a in Equation (9) is 17000 and pixel size Δx is 7 μm because of a 28.6 mm sensor size (Sizeₛₑₙₛₒᵣ) and has 4096 pixels (n).

FIG. 3A illustrates the detected wavelength at each pixel and FIG. 3B illustrates the coherence length at each pixel as the light is dispersed proportionally to wavelength (Linear) and dispersed depending on 1/x dispersion. Here, “1/x dispersion” means that the dispersion in accordance with equation (9). According to FIG. 3B, having the same coherence length over the length of the line-sensor 120 is achieved by a 1/x dispersion.

Spectral intensity changes as the light is dispersed proportionally to wavelength (Linear) is illustrated in FIG. 4A and dispersed depending on 1/x dispersion is illustrated in FIG. 4B.

As the light is dispersed proportionally to wavelength (Linear), the intensity at shorter wavelength decays more than the intensity at longer wavelengths for the greater differences in the optical path length as illustrated in FIG. 4A. Therefore, the resolution of SD-OCT image deteriorates as the difference in the optical path length between signal and reference path in OCT increases. Moreover, as the SD-OCT 100 is expanded to spectroscopic OCT, the accuracy of the spectroscopic information cannot be obtained.

On the other hand, as the light is dispersed depending on a 1/x dispersion, the Intensity at shorter wavelength and longer wavelength are kept essentially the same. Thus, the resolution can be kept at different optical path lengths. In addition to that, the accuracy of the spectroscopic information can be easily obtained at different optical path lengths.

In order to keep the resolution over ½ at the different lengths as the signal intensity decays by a value of ½, a ratio between maximum and minimum in the spectral region is over ½ when the average of spectral intensity is ½. However, those levels can be set depending on applications.

### Example 1

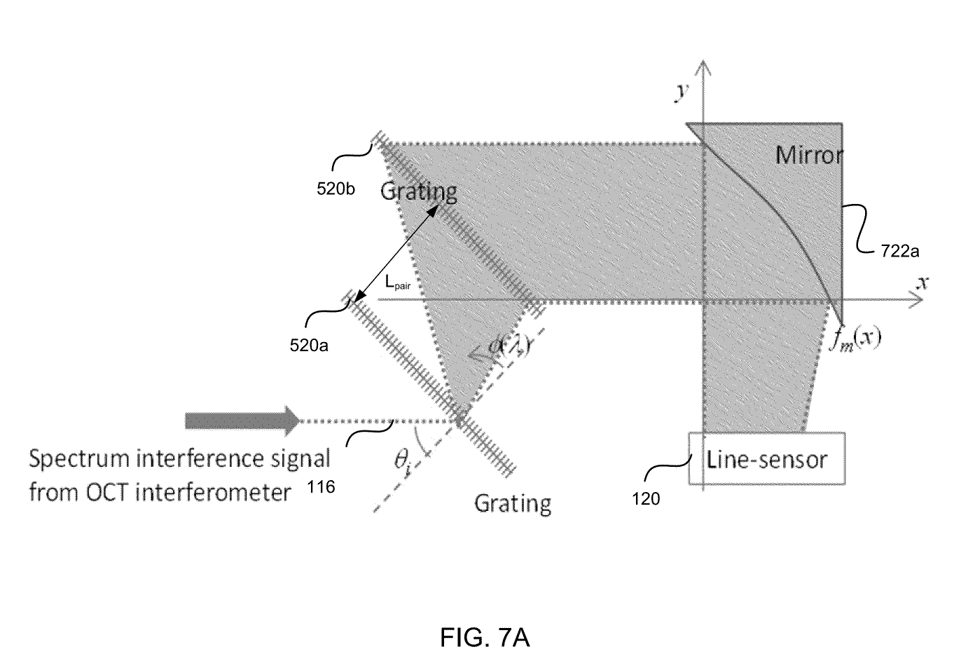

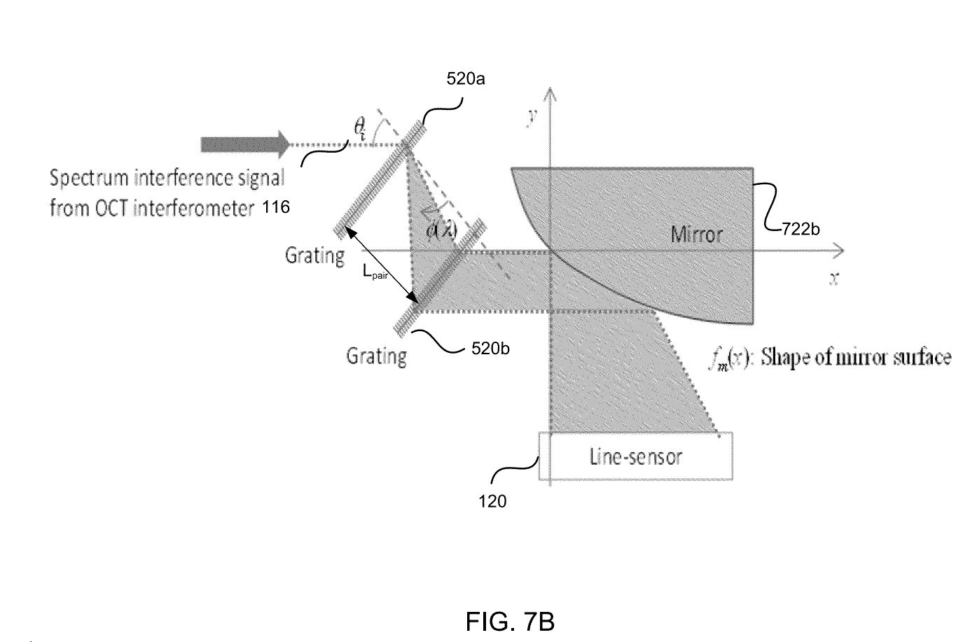

FIGS. 7A-B are illustrations of two embodiments of example 1.

In this example, a mirror 722a or 722b with a special shape is put between the grating pair 520a-b and the line sensor 120 to reduce the differences in the coherence length at each pixel of the line sensor. The shape of the mirror is described by a function fₘ(x) which will be explained as follows.

In this example, mirror 722a or 722b has a designed curve in order to realize that the spectrum is dispersed on the line-sensor as 1/x, is used.

Spectrum interference signal 116 from interferometer in the OCT system 100 is irradiated onto the grating pair 520a-b. This grating pair 520a-b disperses the signal spatially in accordance with equation 12 which is substantially the same as equation (8).

y(λ)=Lₚₐᵢᵣ×cos(θᵢ)×(tan(φ(λ))−tan(φ(λₛ))) (12)

Lₚₐᵢᵣ: Distance between gratings

Here, shape of designed mirror surface is as fₘ(x). The reflected point on the mirror is described in the following equation (13).

$$( \begin{matrix}{x}_{c} \\ {y}_{c}\end{matrix} ) = ( \begin{matrix}{x}_{c} \\ {f}_{m} ( {x}_{c} )\end{matrix} ) = ( \begin{matrix}{x}_{c} \\ y ( λ )\end{matrix} ) = ( \begin{matrix}{x}_{c} \\ {L}_{pair} \times cos ( {θ}_{i} ) \times ( tan ( φ ( λ ) ) - tan ( φ ( {λ}_{s} ) ) )\end{matrix} ) \qquad ( 13 )$$

The coordinate (x_{c}, y_{c}) is coordinate on the designed mirror 722a-b surface. The slope of the tangent at the reflected point is derived as fₘ′(x_{c}) by differentiating fₘ(x).

Thus the reflected beam path is described by the following equation.

$${f}_{r} ( x ) = \frac{2 \cdot {f}_{m}^{′} ( {x}_{c} )}{1 - {( {f}_{m}^{′} ( {x}_{x} ) )}^{2}} \cdot ( x - {x}_{c} ) + {y}_{c} \qquad ( 14 )$$

x_{c} and y_{c} can be calculated based on Equation (13).

The position of the line-sensor is yₛₑₙₛₒᵣ, can be calculated based on Equation (14) as described in the following equation (15).

$${y}_{sensor} = \frac{2 \cdot {f}_{m}^{′} ( {x}_{c} )}{1 - {( {f}_{m}^{′} ( {x}_{x} ) )}^{2}} \cdot ( x - {x}_{c} ) + {y}_{c} \qquad ( 15 )$$

Therefore, if the grating pair specification and line-sensor position are determined, the relation between x and λ can be calculated based on Equation (15).

And fₘ(x) satisfies the relation between x and λ described by Equation (9).

### Example 2

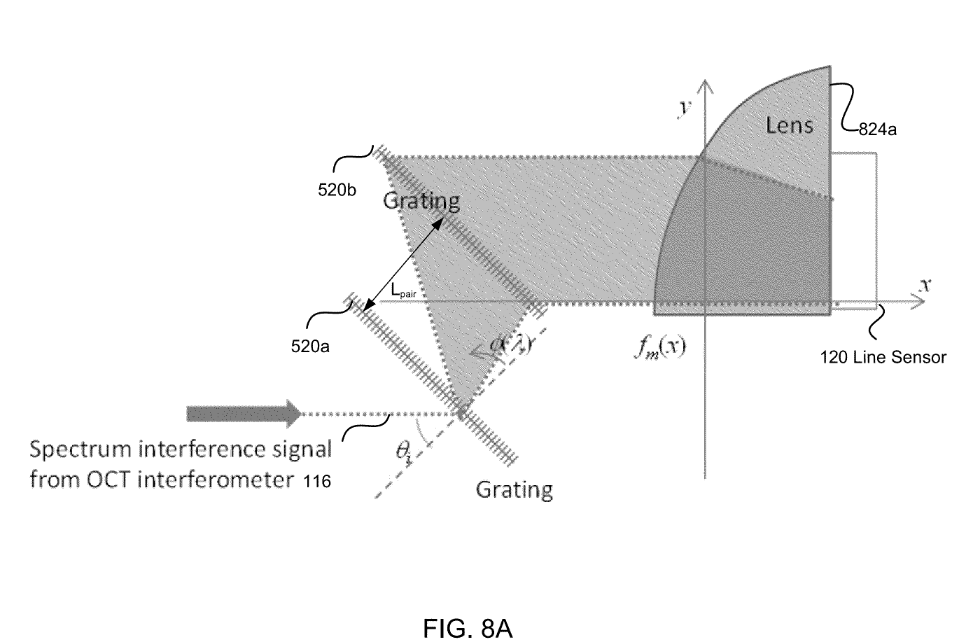

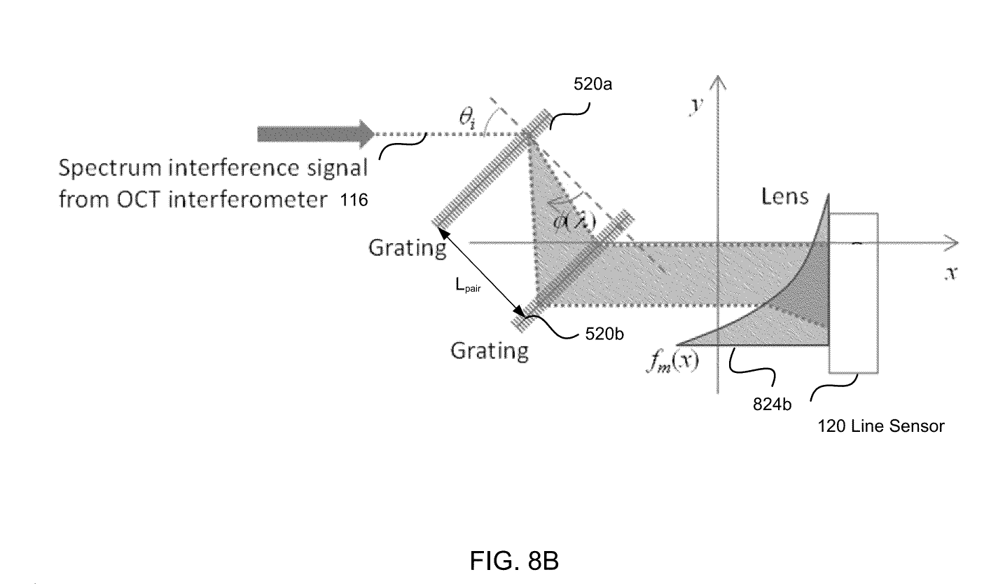

FIGS. 8A-B are illustrations of two embodiments of example 2.

In this example, a lens 824a or 824b with a special shape is put between grating pair 520a-b and line sensor 120 to reduce the differences in the coherence length at each pixel of the line sensor. The shape of the lens is described by fₗ(x) which will be explained as follows.

In Example 2, a specially designed lens 824a or 824b is used instead of a specially designed mirror 722a or 722b as used in Example 1.

The function of fₗ(x) is described as follows.

$$( \begin{matrix}{x}_{c} \\ {y}_{c}\end{matrix} ) = ( \begin{matrix}{x}_{c} \\ {f}_{l} ( {x}_{c} )\end{matrix} ) = ( \begin{matrix}{x}_{c} \\ y ( λ )\end{matrix} ) = ( \begin{matrix}{x}_{c} \\ {L}_{pair} \times cos ( {θ}_{i} ) \times ( tan ( φ ( λ ) ) - tan ( φ ( {λ}_{s} ) ) )\end{matrix} ) \qquad ( 16 )$$

Angle θᵢₗ between normal to lens surface and dispersed light axis is calculated based on Equation (17).

$${θ}_{il} = \frac{π}{2} - arctan ( {f}_{l}^{′} ( x ) ) \qquad ( 17 )$$

The refracting angle θ₁ is calculated using equation (18).

$${θ}_{l} = arcsin ( \frac{sin ( {θ}_{il} )}{{n}_{index}} ) \qquad ( 18 )$$

Therefore the refracting optical path fₘ(x) is described using equation (19).

fₗᵣ(x)=tan(−θᵢₗ+θₗ)·(x−x_{c})+y_{c} (19)

From the equation (19), the y value at the position xₛₑₙₛₒᵣ of line sensor is described as follows.

y(λ)=tan(−θᵢₗ+θₗ)·(xₛₑₙₛₒᵣ−x_{c})+y_{c} (20)

Thus fₗ(x) can be determined so as to satisfy both equations (9) and (20).

### Example 3

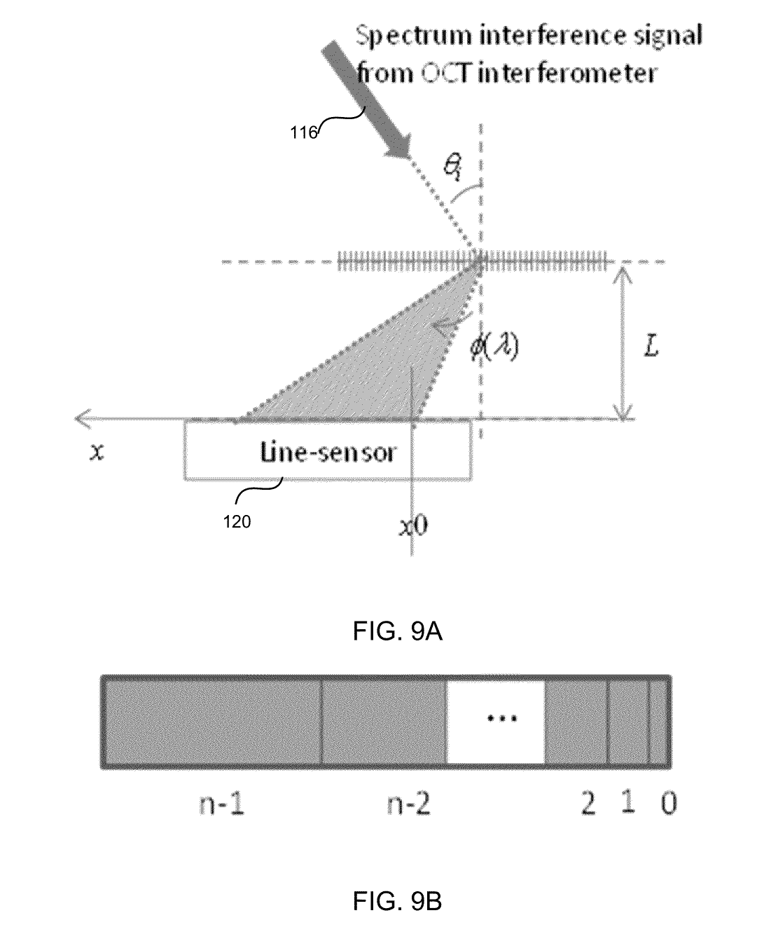

FIGS. 9A-B are illustrations of an embodiment of example 3. The relative sizes of the different pixels size of the line-sensor 120 are illustrated in FIG. 9B. In example 3, pixel sizes are different to reduce the differences in the coherence length at each pixel of the line sensor.

In example 3, each pixel size depends on the position in line-sensor 120.

As the pixel size at the i-th is described as ps (i), the center position pc(i) of the i-th pixel is described by the following equation (21).

“i” means pixel number thus i=0˜n−1.

$$pc ( i ) = {\sum }_{j = 0}^{i - 1} ( ps ( j ) ) + \frac{ps ( i )}{2} \qquad ( 21 )$$

The relation between position x and wavelength λ is can be described using equation (22).

$$λ = \frac{sin ( {tan}^{- 1} ( \frac{x}{L} + tan ( φ ( {λ}_{s} ) ) ) ) + sin ( {θ}_{i} )}{md} \qquad ( 22 )$$

In accordance with equation (5), the following equations (23)-(24) can be calculated in order to achieve that the coherence lengths are substantially the same for all the pixels of the line sensor 120.

$$\begin{matrix} \frac{{λ}_{c}^{2}}{Δλ} = a ( constant ) & ( 23 ) \\ {\{ sin ( {tan}^{- 1} ( \frac{pc ( i )}{{L}_{pair}} + tan ( φ ( {λ}_{s} ) ) ) ) + sin ( {θ}_{i} ) \}}^{2} = a \times md \times \{ \begin{matrix}sin ( {tan}^{- 1} ( \frac{( pc ( i ) + ps ( i ) / 2 )}{{L}_{pair}} + tan ( φ ( {λ}_{s} ) ) ) ) - \\ sin ( {tan}^{- 1} ( \frac{( pc ( i ) - ps ( i / 2 )}{{L}_{pair}} + tan ( φ ( {λ}_{s} ) ) ) )\end{matrix} \} & ( 24 )\end{matrix}$$

Thus, as the specification of grating 118 and position of the line-sensor 120 are settled on, the design of the line-sensor 120 can be determined based on equation (24).

### Example 4

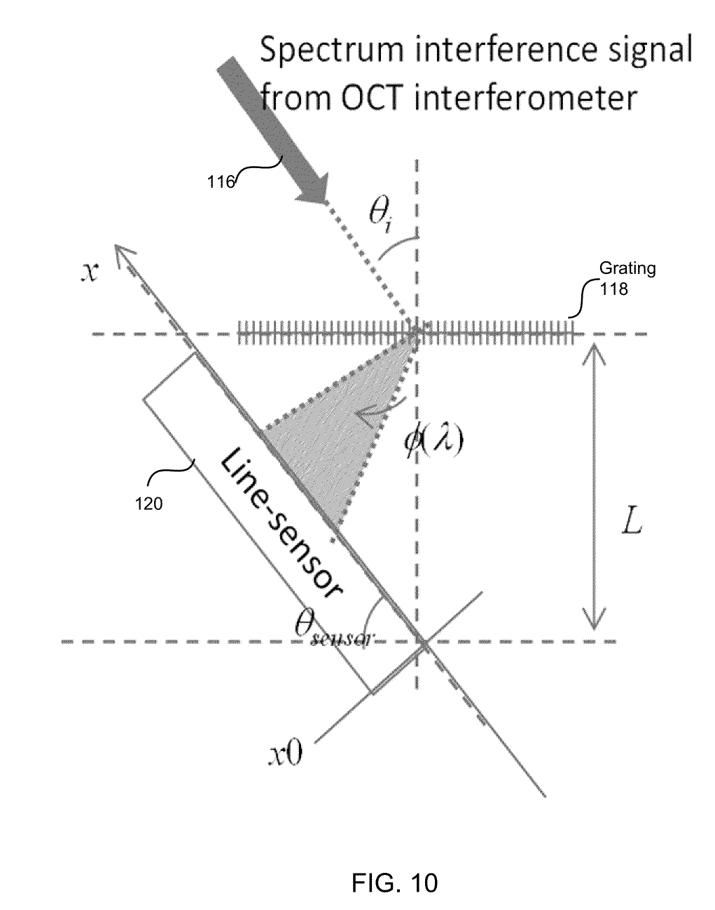

FIG. 10 shows schematic of this example. In this example, an angle between the line sensor and dispersed optical path is optimized to reduce the differences of coherence length at pixels.

In this example, the line-sensor is set as angle is tilted. The deflected angle may be calculated using equation (7).

$$\begin{matrix}λ = ( \frac{x \cdot sin ( {θ}_{sensor} )}{\sqrt{{x}^{2} + {L}^{2} - 2 \cdot x \cdot L \cdot cos ( {θ}_{sensor} )}} + sin ( {θ}_{i} ) ) \times \frac{1}{md} & ( 25 ) \\ L = {Size}_{sensor} \times {( \frac{sin ( φ ( {λ}_{l} ) )}{sin ( φ ( {λ}_{l} ) + {θ}_{sensor} )} - \frac{sin ( φ ( {λ}_{s} ) )}{sin ( φ ( {λ}_{s} ) + {θ}_{sensor} )} )}^{- 1} & ( 26 )\end{matrix}$$

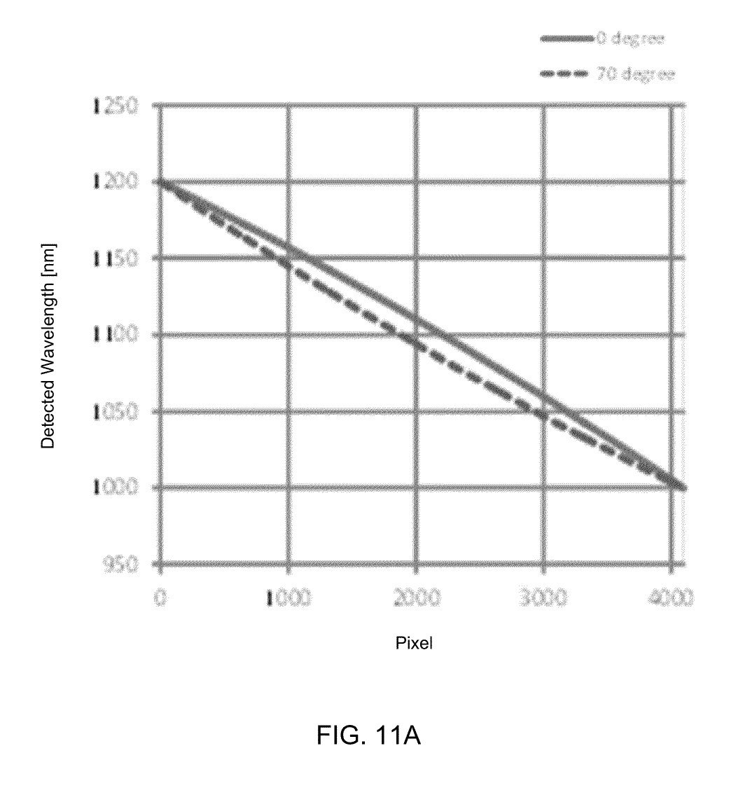

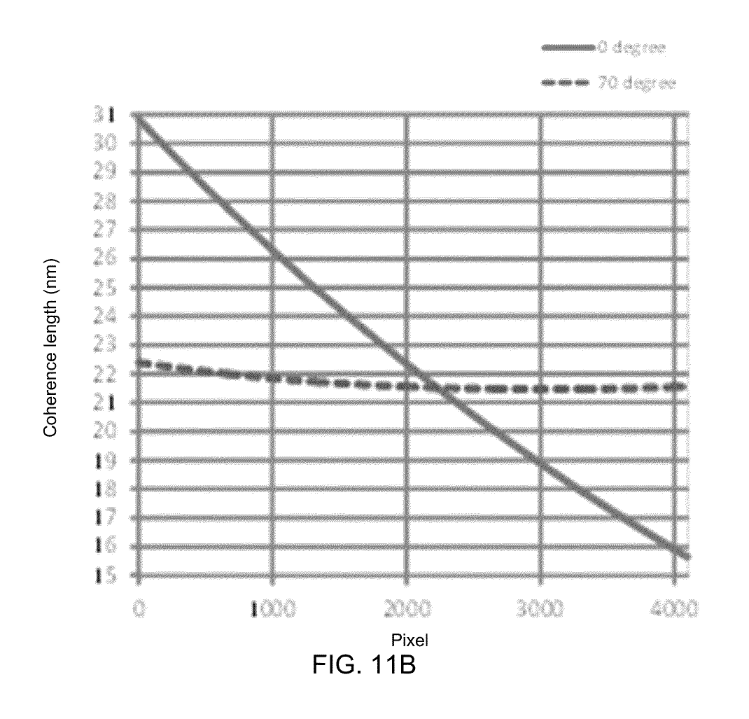

FIGS. 11A-B are illustrations of the results comparing sensor angle θₛₑₙₛₒᵣ at 0 degrees and 70 degrees.

Those results are calculated for m=1, d=980, λₛ=1000 nm, λₗ=1200 nm, incident angle θᵢ=46.5 degree and pixel number=4096 (n).

In example 4, the flatness of coherence length is improved but not ideal.

Detected wavelength and coherence length at each pixel are illustrated by the data lines Single grating at optimized angle in FIGS. 3A-B. FIG. 4E illustrates the spectral intensity variation as the length between signal and reference optical path changes. By this example, as the average of spectral intensity is ½, the ratio between maximum and minimum in the spectral region is over 9/10. It means that the resolution does not decay over 9/10.

### Example 5

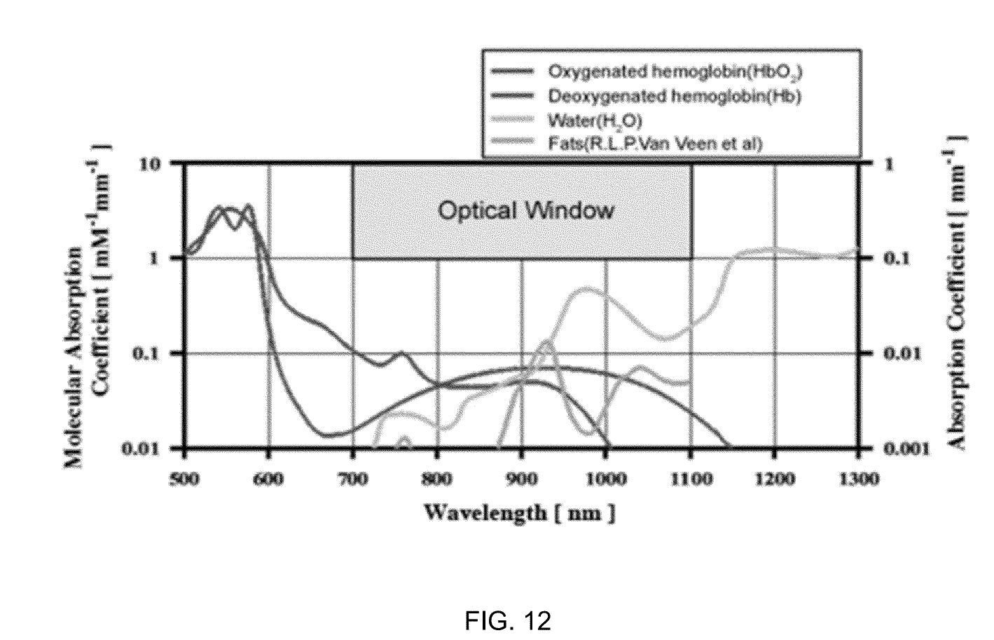

In example 5, the coherence length in a deep region of the target sample 112 is compensated by controlling each spectrum width detected at each pixel of the lines 120. FIG. 12 is an illustration that shows loss by scattering and absorption of water and blood. As the light comes back from more deep tissue, the spectrum is affected by characteristics of the target sample. Thus, the spectral shape coming from deep tissue is changed. Those spectral changes can be compensated for by controlling the each coherence length at each pixel by controlling the spectrum width detected at the each pixel.

As light source 102 with spectral range of 1000-1200 nm and the target sample is immersed in deep water, the loss is smaller at the center wavelength of 1100 nm than at the around spectrum. Thus the detected spectrum width at each pixel is controlled based on the loss of water such as the broader at the center wavelength than at the around wavelengths, the depth resolution at the deep tissue is kept.

In the SD-OCT 100, the depth resolution is not deteriorated according to the depth. In spectroscopic SD-OCT 100, the spectroscopic information is not changed according to the depth.

In spectral domain optical coherence tomography (SD-OCT), spectral interference signal is detected by a line-sensor 120 and all coherence lengths at all pixel of the line-sensor are same by controlling the detected spectrum width at each pixel.

In order to obtain a substantially flat coherence length at all the pixels in the lines, as the detected wavelength at a pixel is longer wavelength, the spectrum width is broader.

In order to control the detected spectral width according to detected wavelength, the spectrum dispersion in space is controlled by specially designed mirrors 522a-b or lenses 724a-b.

In order to control the detected spectral width according to detected wavelength, the each pixel of the line-sensor 120 is specially designed.

In order to control the detected spectral width according to detected wavelength, position and angle relation between dispersive device 118 and line-sensor 120 is controlled.

In order to compensate characteristics of target sample, the spectrum width detected at each pixel is controlled by above methods such as designed mirrors or lenses, designed line-sensor, relation between the dispersive device and the line-sensor and so on.

What is claimed is:

1. A spectral domain optical coherence tomograph comprising:
a light source, a beamsplitter, a reference arm, a dispersive device, and a sensor array;
wherein the dispersive device is a spatial chromatic dispersive device that spreads an interference light signal produced by the beamsplitter such that different wavelengths of the interference light signal are directed at different areas of space;
wherein the sensor array comprises a plurality of N pixels,
wherein each pixel in the sensor array is identified by an index i,
wherein the sensor array is positioned relative to the dispersive device such that each pixel i detects wavelengths of the interference light having:
a spectral width Δλᵢ;
a central wavelength λ_{ci};
having a coherence length defined as
$$Δ {l}_{i} ∝ \frac{{λ}_{ci}^{2}}{{Δλ}_{i}}$$
wherein a reflective or refractive optical element is placed between the dispersive device and the sensor array to transform the spatial chromatic dispersion such that Δli=Δli+j is obtained for each pixel in the sensor array.

2. A spectral domain optical coherence tomograph comprising:
a light source, a device for splitting light, a reference arm, a dispersive device, and a sensor array;
wherein the dispersive device is a spatial chromatic dispersive device that spreads an interference light signal produced by the device for splitting light such that different wavelengths of the interference light signal are directed at different areas of space;
wherein the spectral domain optical coherence tomography is configured so that a ratio between the maximum and minimum of the Interfered spectral signal intensity is equal to or more than a predetermined value when the average of spectral intensity is ½.

3. The spectral domain optical coherence tomograph according to claim 2, further comprising a reflective optical element placed between the dispersive device and the sensor array so that the ratio between the maximum and minimum of the Interfered spectral signal intensity is equal to or more than the predetermined value when the average of spectral intensity is ½.

4. The spectral domain optical coherence tomograph according to claim 2, further comprising a reflective optical element placed between the dispersive device and the sensor array so that spectral loss by sample is compensated.

5. The spectral domain optical coherence tomograph according to claim 2, further comprising a reflective optical element is placed between the dispersive device and the sensor array to transform the spatial chromatic dispersion so that spectral loss by sample is compensated.

6. The spectral domain optical coherence tomograph according to claim 2, further comprising a refractive optical element placed between the dispersive device and the sensor array so that the ratio between the maximum and minimum of the Interfered spectral signal intensity is equal to or more than the predetermined value when the average of spectral intensity is ½.

7. The spectral domain optical coherence tomograph according to claim 2, further comprising a refractive optical element placed between the dispersive device and the sensor array so that spectral loss by sample is compensated.

8. The spectral domain optical coherence tomograph according to claim 2, further comprising a refractive optical element placed between the dispersive device and the sensor array to transform the spatial chromatic dispersion so that spectral loss by sample is compensated.

9. The spectral domain optical coherence tomograph according to claim 2,
wherein the line-sensor has a designed pitch such that spectral loss by sample is compensated.

10. The spectral domain optical coherence tomograph according to claim 2,
wherein the line-sensor has a designed pitch so that the ratio between the maximum and minimum of the Interfered spectral signal intensity is equal to or more than the predetermined value when the average of spectral intensity is ½.

11. The spectral domain optical coherence tomograph according to claim 2,
wherein the sensor array is arranged so that the ratio between the maximum and minimum of the Interfered spectral signal intensity is equal to or more than the predetermined value when the average of spectral intensity is ½.

12. The spectral domain optical coherence tomograph according to claim 2,
wherein the predetermined value is ½.

13. A spectral domain optical coherence tomograph comprising:
a light source, a device for splitting light, a reference arm, a dispersive device, and a sensor array;
wherein the dispersive device is a spatial chromatic dispersive device that spreads an interference light signal produced by the device for splitting light such that different wavelengths of the interference light signal are directed at different areas of space;
wherein the sensor array comprises a plurality of pixels,
wherein each pixel in the sensor array is identified by an index i,
wherein the sensor array is positioned relative to the dispersive device such that each pixel i detects wavelengths of the interference light having:
a spectral width Δλᵢ;
a central wavelength λ_{ci};
having a coherence length defined as
$$Δ {l}_{i} ∝ \frac{{λ}_{ci}^{2}}{{Δλ}_{i}}$$
wherein the spectral domain optical coherence tomography is configured so that Δli is substantially identical to Δli+j.

14. The spectral domain optical coherence tomograph according to claim 12, further comprising a reflective optical element placed between the dispersive device and the sensor array so that Δli is substantially identical to Δli+j.

15. The spectral domain optical coherence tomograph according to claim 12, further comprising a refractive optical element placed between the dispersive device and the sensor array so that Δli is substantially identical to Δli+j.

16. The spectral domain optical coherence tomograph according to claim 12,
wherein the line-sensor has a designed pitch so that Δli is substantially identical to Δli+j.

17. The spectral domain optical coherence tomograph according to claim 12,
wherein the sensor array is arranged so that Δli is substantially identical to Δli+j.
